(19) United States
(12) Patent Application Publication
(10) Pub. No.: US 2006/0115130 A1
(43) Pub. Date: Jun. 1, 2006

(54) Eyewear with biometrics to protect displayed data

(76) Inventor: Douglas Kozlay, Timonium, MD (US)

Correspondence Address: Douglas Kozlay, Suite 304, 9475 Deereco Road, Timonium, MD, 21093, US

(21) Appl. No.: 10/998,789

(22) Filed: Nov. 29, 2004

(51) Int. Cl. G06K 9/00

(52) U.S. Cl. 382/117; 340/5.74

(57) ABSTRACT

The invention disclosed provides a mobile, portable, secure, eyewear display system with an attached or embedded miniaturized display, with user access controlled by biometric (or other) identity credentials. Effectively, the invention detects users “coming and going”, ensuring users only display and access data they have privileges to access. Users initially provide biometric (fingerprints, iris, retina, voice, etc.) and/or non-biometric identity credentials to enroll in (and subsequently authenticate themselves to) the eyewear display system. The system also detects when a user physically exits the system, using one or more “presence detection” devices (e.g., optical, acoustic, iris, or retinal presence sensors), thereby ensuring every user is authenticated prior to each session. One or more display screens can be embedded in (and/or attached onto) one or both lenses in the eyewear display system. An external identity credential interface subsystem is also disclosed, which permits use of externally-provided (biometric and/or non-biometric) identity credentials.

### BACKGROUND OF THE INVENTION

1. Field of the Invention

The field of the invention is security and biometric authentication for accessing data/information; more particularly, security and biometric authentication for accessing and viewing data/information on a miniaturized, “heads up” display screen embedded in eyeglasses lens of an eyewear display system.

2. Related Art

There appears to be no directly related art. In indirectly related art, some products use “heads up” displays in commercial and military vehicles and aircraft cockpits—e.g., a signal feed source projects displayable images onto windshield glass—allowing users (e.g., drivers, pilots, etc.) to easily view operational data. Other patents disclose eyewear systems used for monitoring systems (e.g., exercise monitoring systems, systems for monitoring eye movement, etc.), to wit:

U.S. Pat. No. 6,736,759 to Stubbs discloses an exercise monitoring system and display. This invention is ostensibly configurable to project data and other information onto headwear worn by a subject—e.g., swimming goggles, a visor, eyeglasses, or a display screen or other device positioned on a person's head—so that data/information displayed thereon is directly visible to the subject. Additionally, this patent cites and includes by reference, patent applications WO/9923524 and WO/9923525, which disclose devices which can be used as components for product configurations such as those suggested by the Stubbs patent. The Stubbs patent discusses “security” only tangentially (but does not discuss biometrics or data/information security controls), but only from the standpoint of monitoring user eye blinks for triggering of alarms in emergency situations. Notwithstanding the fact that the Stubbs patent and products it protects appear useful for exercise monitoring applications and other applications, and some eye blink applications, the Stubbs patent is silent on the topic of data/information security and biometrics for biometrically authenticating users to control, restrict, and limit user access to facility secured and/or sensitive data/information.

U.S. Pat. No. 6,542,081 to Torch discloses a system and method for monitoring eye movement. The system includes a frame worn on a person's head for directing light towards the person's eye, an array of sensors on the frame for detecting light from the array of emitters. Although the patent and the product it protects does in fact disclose a form of security alarm triggered by an eye blink pattern, the patent is silent on the topic of biometric authentication.

U.S. Pat. No. 6,483,483 to Kosugi, et al, discloses an eyeglasses-type image display apparatus that can be connected to a computer having a large amount of information so it can display information from the computer on a large screen and/or display information on eyeglasses, apparently. The apparatus is adapted for mounting on a head of a user to display an image in front of eyes of the user, and includes a connector capable of receiving information from a computer, a processor for processing the information, and a display unit for displaying an image based on the information processed. The connector includes a wire or a radio section for transmitting information. The display unit can display an image and has a see-through function for allowing the user to see the external world therethrough. Despite the apparent benefits of this patent and the product(s) it protects, the patent is silent on security for restricting, limiting, and controlling access to data/information accessible on the display apparatus of the Kosugi invention. There is no provision in the Kosugi patent for limiting user access, to data/information, unlike the eyewear display system of the present invention, which includes a biometric authentication module for receiving biometric identification credentials from users as prerequisite for granting access to the eyewear display system of the present invention.

U.S. Pat. No. 6,734,845 to Nielsen, et al. discloses the detection of eye motion to see if an individual is watching a display screen. If the screen is not being watched, then the display can be shut down to conserve power. A motion detector activates a proximity detector and/or an IR detector to ensure that power is applied only when a user is actually present. This patent does not mention eyewear and does authenticate the individual nor does it turn off the display to control the viewing of sensitive information.

### NECESSITY OF THE INVENTION

There's a well-known, widely-felt need, to control, restrict, and limit access to image data and/or audio data by information technology users. Security policies are mandatory in most all facilities that work with sensitive data/information, e.g., private sector facilities (commercial, financial, medical, high-tech, etc.); public sector facilities (military, government, police, etc.); and many private and standalone users as well.

Restrictions/limits on any user's access to privileged image data and/or audio data are typically determined, promulgated, and enforced by facility authorities (executive management, data owners, data administrators, security administrators, etc.).

A variety of different “security level” strategies and tactics may be assigned and implemented. For example, in government and military environments, data and information is often considered “sensitive”—i.e., subject to being “classified” even more specifically depending on its' secrecy—or conversely, data and information can sometimes be considered “unclassified”—i.e., suitable for distribution to the public, with no restrictions. More specifically, in the case of “classified” data and information, frequently the lowest level of security is considered “confidential”; the next level (higher security) assigned is “secret”; the next level is “top secret”; and the topmost level (highest security) is termed (e.g.) “special compartmented information”. Of course, depending on the facility, its location, and its specific security strategies and tactics, other classification schemes are used. If eyewear display devices that are not biometrically authenticated are used to display sensitive information, then anyone who picks up the eyewear can access information intended only for the person who previously used it. This emphasizes that there is a definite need in the art for display screen eyewear that requires an individual to biometrically authenticate their identity when the eyewear is placed on his or her head, before the device displays sensitive information.

Although the art of data/information security is large and growing larger—with many patents and products providing apparatuses, methods and systems to the expanding arsenal of security controls—prior to the present invention, there is no biometrically-secured “eyewear display system” extant in the art. Accordingly, it is observed, there's a need in the art for the present invention, a biometrically-secured eyewear display apparatus, method, and system for controlling, restricting, and limiting access to data/information.

### OBJECTS OF THE INVENTION

Accordingly, it is one object of the invention, to provide biometrically-authenticating eyewear display system to control user access to restricted data and information which must be accessed only in accordance with any individual user's specific access privileges.

It is a related object, to provide an eyewear display system which is ergonomic, secure, mobile, lightweight, and essentially unobtrusive, which also provides delivery of (and access to) private, individually-accessible, personal, “for your eyes only” data, but only for a successfully biometrically authenticated user.

It is another object, to provide an eyewear display system which only presents local image data and/or local audio data when on a user's head, and which requires the user to be authenticated each time the eyewear is placed on their head, to ensure data displayed thereupon is appropriate to display privileges authorized for the user.

It is another object, to provide both wired and wireless connectivity options for transmitting and receiving data, information, and image signal feeds to and from an eyewear display system.

It is another object, to provide a portable battery option for providing electrical power to an eyewear display system to facilitate mobility and portability.

### SUMMARY OF THE INVENTION

The present invention provides apparatuses, methods, and a system for biometrically controlling eyewear-based access to presented image data and/or audio data. The invention can be specifically customized to reflect the security policies of any particular security system. Most security-oriented facilities using sensitive data have specific security policies for controlling, restricting, and limiting user access to data and information. The invention accomplishes this and other objects of the invention, by means of biometric authentication of pre-enrolled users. Once a pre-enrolled user has been biometrically authenticated by the biometric authentication module (integrally attached to the eyewear display system) the user is allowed to access image and/or audio data on the eyewear display system. This is accomplished by communicating an image and/or audio signal feed into one or more miniaturized display(s) and/or one or more audio speakers installed in the eyewear display system. Image display(s) can be mounted in front of or embedded within one or both lenses mounted in the eyeglasses frame. Audio data can be presented to speaker(s) disposed within the eyeglasses frame. The signal feed (and subsequent transmission and reception of data, information, images, etc.) is conducted either by a wired and/or a wireless communication interface. The source of the signal feed can be either external to the eyewear display system and/or can be internally supplied, depending on configurations implemented and ancillary devices (e.g., peripheral devices) deployed. Power for the eyewear display system is provided either by a wire-connected portable battery (which is carried by the user when in transit) that can be clipped onto the user's belt, or fastened onto the user or his belt by a fastener or other attaching means. Electrical power to the eyewear display system can be provided by a direct wire connection to the eyewear system from an external power source, and/or provided by a portable battery.

Alternatively, the present invention can be implemented with a projection based signal feed source which can project viewable data and information into one or both eyes of the user, but only after the user has been biometrically authenticated, in order to ensure that each user only views the data they are allowed to access.

The invention is useful for ergonomic, mobile, portable environments where secure and/or sensitive data and information are used by biometrically-authenticated users, and is particularly helpful where there is a risk that there are persons present (in the vicinity of the biometrically authenticated user using the eyewear display system) who have varied degrees of access permissions to the displayed information and/or a differing need to know the displayed information. If ordinary eyewear display devices are used to display the data, then anyone who picks up the device can access data intended for the person who previously used it. The present invention fills a current unfulfilled need in the marketplace for a secure, biometrically-authenticating eyewear display system. The system requires a pre-enrolled user to biometrically authenticate their identity at the time the invention is placed on his/her head, as a security prerequisite, before the device will display any sensitive data/information.

### BRIEF DESCRIPTION OF THE DRAWINGS AND REFERENCE NUMERALS

FIG. 1A shows an alternative embodiment of the Biometrically-Controlled Eyewear Display System in which an iris or retinal scanner is integrated into a display unit such that the introduction of the user's eye into the display area initiates the biometric authentication process.

FIG. 1B is a detail of the Combination LCD Display and Iris/Retina Scanner of FIG. 1A.

FIG. 2 shows the Biometrically-Controlled Eyewear Display System implemented on eyeglasses platform, including integrated attached battery pack, head presence switch, attached fingerprint biometric authentication module, and embedded miniature display.

FIG. 3 shows the sequence of events authenticating a user and displaying the appropriate data while the user continues to wear the eyewear.

FIG. 4 shows a Flow Chart for the simple example of a system in which there are two levels of security associated with the displayed data and this chart can be seen to be extensible for multiple security levels.

### REFERENCE NUMERALS

10 Eyeglasses Lens including Embedded Miniaturized “Heads-Up” Display
12 Eyeglasses Frame
13 Head Presence Switch
14 Attachable Biometric Authentication Module
15 Combination LCD Display and Iris/Retina Scanner
16 Portable Battery Pack with Power Cord and Belt Clip
18 Signal Feed Termination and/or Source
19 Communications Link between Signal Feed and Eyeglass System
20 Embedded Miniaturized “Heads-Up” Display
22 Human Eye
24 Half Silvered Mirror
26 Lens Assembly
28 Silicon Photosensor Array
30 LCD Display Array

### DETAILED DESCRIPTION OF THE INVENTION

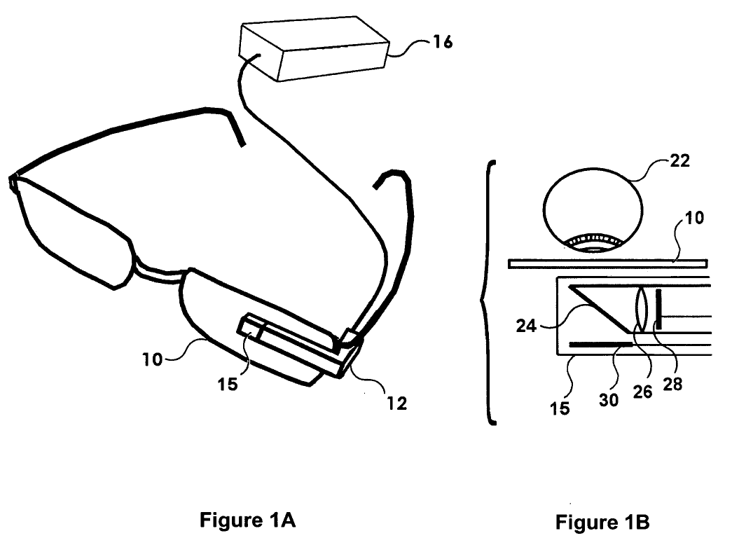

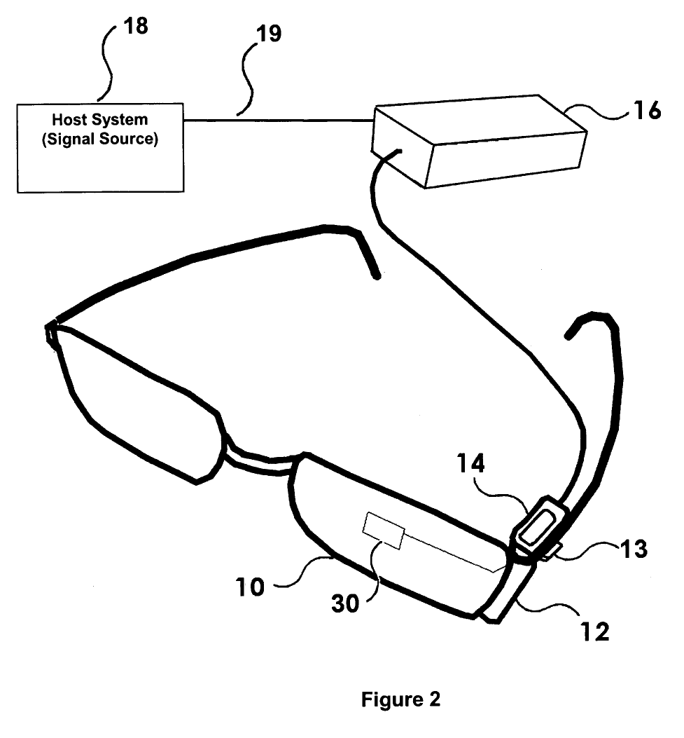

The present invention provides an eyewear display system, which provides effective means for biometrically authenticating pre-enrolled users thereto. The eyewear display system integrates a biometric sensor that can determine the identity of the wearer who seeks to access image and/or audio data that is secured, sensitive, or otherwise subject to security controls, restrictions, and limitations on usage and viewing. The present invention enables presentation of image data (and/or presentation of an audio feed) that's been predetermined by a security-oriented facility, to be suitable for display to any individual user the present invention, based on that user's privileges. All access to the eyewear display system is based on prospective user(s) having been first biometrically authenticated as well as having been explicitly allowed to access to facility data/information. Access to audio data is via an earphone or an earbud attached to the eyeglasses frame (not shown). One primary embodiment of the system includes a biometric authentication module with an embedded iris scanner subsystem as shown in FIG. 1. However, optionally, an Eyewear Display System can use other forms of biometric credentials to authenticate prospective users. For example, another primary embodiment of the biometric authentication module can implement fingerprint scanning and/or other biometric credential authentication modality as shown in FIG. 2. Additionally, in another version of the present invention, there can also be implemented an optional external identity credential interface subsystem for authenticating and relaying externally-provided (biometric and/or non-biometric) user identity credentials into the independent eyewear display system. To emphasize this optional capability, it is observed that some authentication devices (e.g., smartcard readers, external fingerprint sensors, etc.) may not practically fit on the eyewear frame of the system, necessitating usage of the aforementioned external identity credential interface subsystem (not shown). In its' most basic primary embodiment, the system of the invention is ergonomic and user-friendly, due to implementation using the familiar “eyeglasses” form factor. The system is also intuitive to operate and easy to use.

In the case of the embodiment of the present invention with the embedded fingerprint, iris or retinal sensor subsystem, the biometric authentication module 14 receives user-authenticating biometric data inputs from the embedded sensor 14 subsystem in order to perform immediate self-authentication. The reference biometric template and biometric authentication processing may take place within in the sensor device itself, or may take place in an interconnected (internal and/or external) control system connected by a wired connection or by a wireless connection to the eyewear display system.

FIG. 1 illustrates a Biometrically-Controlled Eyewear Display System using a Fingerprint Scanner which is implemented on eyeglasses frame 12. Also shown are signal feed source 18, attached battery pack 16, attached biometric authentication module 14, and embedded miniature display 20 embedded into eyeglass lens 10 which receives a signal feed via Communications Link 19 from signal feed source 18. The Communications Link 19 may be either a wired connection or a wireless connection such as Bluetooth or 802.11 as described in the literature such as the MicroOptical, Inc. Products Catalog. Optionally, in one version of the preferred embodiment, the data that is communicated from the eyeglasses can be in unencrypted form, but in another version this communications can be encrypted and in yet another version the parties to the communication can be cryptographically authenticated to prevent unauthorized equipment from being used on the system. This may be accomplished by the use of standard cryptographic protocols that are well known to the art, such as the 802.11b WEP security protocol published by the IEEE or the IPsec Virtual Private Network (VPN) protocol published by the IETF. To further clarify, encryption can be performed to “hide” the transmitted data in accordance with standards such as ANSI X3.92 and data source authentication can be performed to ensure the identity of the sender user using a standard such as ANSI X9.19. The miniature display 20 can be a liquid crystal display (LCD), plasma display or other miniature display technology.

The invention as shown in FIG. 2 integrates fingerprint biometrics and lens-embedded display technology to enforce and limit user access control. Initially, there is no sensitive data sent form the signal feed source 18. When a switch, acoustic transponder, optical proximity sensor or other means detects the presence of the user's head, the user is prompted to place a finger on the biometric authentication module 14 (e.g., a built-in fingerprint scanner 14 or other biometric sensor, depending on configuration). Biometric authentication using fingerprints is well known to the art as taught, for example, by U.S. Pat. No. 4,577,345 to Abramov. The fingerprint (or other biometric) is identified by biometric authentication module 14 (and/or identified externally, by e.g., an external biometric or other control system, e.g., connected by a two-way communications link to signal feed source 18). Each user is accorded various facility-assigned privileges, based on the policies and requirements of the facility which owns and operates the eyewear display system. When authenticating, user's submitted biometrics are compared to a table of pre-enrolled biometric templates for authentication. Data content displayable on display 20 (for any particular user), is accessible only after biometric authentication of each user. Data displayed, is further limited, based on access privileges of any such user. This enables the system to filter out and deny provision of any data content for which any user is not authorized. Additionally, the system can be configured to alert management with an alarm as needed, e.g., if a prospective user cannot be authenticated as an authorized user, but continues to attempt access.

FIG. 2A shows a different display system in which a combination LCD display and iris/retinal scanner 15 is suspended in front of the eye to both authenticate the user and present the appropriate information for that user, based on that user's specific assigned access privileges.

FIG. 2B is a detail of the combination LCD display and iris/retinal scanner 15 showing a portion of the eyeglass lens 10 and a representation of the user's eye 22 showing the iris. The biometric identity measurement that is obtained from the user in this version of one preferred embodiment is either an iris or a retinal scan image obtained by a half-silvered mirror 24 and a lens assembly 26 which projects the image of the iris or retina onto a photosensor array 28. The presence of the iris or retinal image provides the detection of the presence of a user's head and begins the authentication process. In this embodiment, the iris or retinal image biometric provided by a prospective user, is then matched with a reference database of templates (using techniques that are well known to the field of biometrics), resulting in biometric (iris or retina) authentication when the eyeglass wearer is matched and thereby identified. Biometric authentication using the iris of the human eye is well known to the art as taught, for example, by U.S. Pat. No. 4,641,349 to Flom, et al. The table also contains the data access privileges of the identified wearer of the eyewear and the system will only display data that has been identified or labeled as being appropriate for that level of access, which has been granted to that particular user.

Another security aspect of the present invention is the capability to detect the presence or absence of a user. More specifically, the eyewear display system can sense the appearance of a prospective user, so that user can be prompted by the system for authentication. Conversely, when the eyeglasses are removed from the user's head, the system can detect this event and terminate the transmission of sensitive images from the signal feed source to the display. The proximity sensor may be implemented in a number of ways. For example, the proximity sensor can be a mechanical switch 13, coupled to the body of the eyeglasses to sense the motion of a spring-hinged temple (ear-piece) when the frame is spread to place it on the user's head. This switch would have an operating position and a non-operating position, wherein the member is in the non-operating position in the absence of the user from the eyeglass frame and the switch is moved to the operating position when the user has placed the eyeglass frame on his or her head. Alternatively, the proximity detector may be electronic and may include a semiconductor device. The presence sensing mechanism may be optical, such as an infrared (IR) reflection detector, or acoustic, such as a high-frequency sonic range detector. Another example of a presence detection mechanism is the detection of the presence or absence of an iris image obtained from the silicon photodetector array 28 by the processor. Eye presence detectors are known to the art as taught by U.S. Pat. No. 6,734,845 to Nielsen, et al.

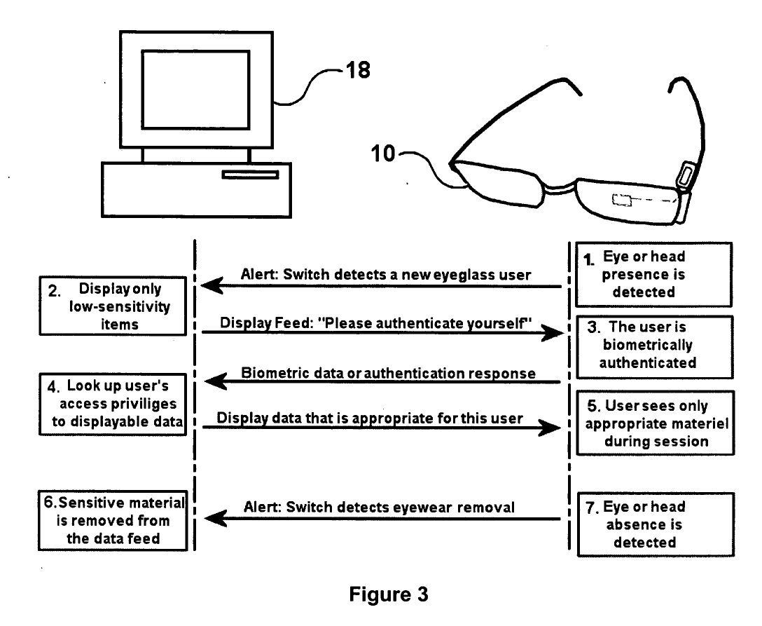

FIG. 3 is a chart showing the steps from the time that the eyewear detects the presence of a user, to the generation of an explanatory (and/or prompting) message to the user “to biometrically authenticate” e.g., a finger (or, e.g., explanatory message, stating that a user iris or retina is being scanned for biometric authentication) in order to identify the current eyewear user, generating the lookup of the authenticated user's privileges in a computer connected to the display feed, generating the display of the appropriate data, and finally, detection of the removal of the eyewear and subsequent shutdown of the display.

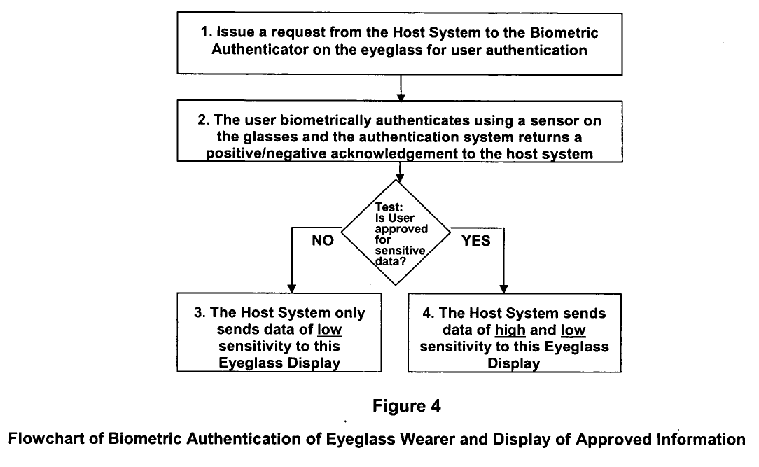

FIG. 4 shows a flowchart of a biometric authentication of a user (a prospective user of the eyeglass display system). FIG. 4 also shows logic associated with different scenarios of the man-machine interface (i.e., either “authentication” or “no authentication”). It is a detail of the privilege lookup of FIG. 3 in the special case that there are only two anticipated levels of viewer access, non-sensitive or sensitive. If there are more levels of data sensitivity (confidential, secret, top-secret, etc.) then this is a multi-branch decision that is best represented by a table lookup of authorized users, pre-recorded biometric features, and pre-assigned access levels (not shown). Failure to authenticate the required user biometric (e.g., fingerprint, retina, or iris, or etc.) results in no sensitive data and/or information signals being fed from the signal feed source, and can also result in the generation and sending of an alert appropriate facility administrator or facility security officer, if alarms are implemented. Based on the foregoing, it will be obvious for one skilled in the art to recognize other possible variations of this system. Accordingly, this invention is not limited only by disclosures herein.

I claim:

1. An eyewear display system for presenting data from at least one signal feed source, comprising:
an eyeglasses frame;
a biometric authentication module coupled to said eyeglasses frame for biometrically authenticating a user;
at least one lens mounted within said eyeglasses frame;
at least one of a display screen coupled to said at least one lens;
at least one electrical power source for providing electrical power; and
a communications link for receiving signals from said at least one signal feed source and for relaying received signals to said at least one display screen after said user has been authenticated.

2. The system of claim 1, wherein said signals received from said signal feed source further comprise at least one of image data and audio data.

3. The system of claim 1, wherein said biometric authentication module further comprises a biometric iris identification sensor.

4. The system of claim 3, further comprising a processor having at least one iris matching algorithm for authenticating the iris of said user.

5. The system of claim 1, wherein said biometric authentication module further comprises a biometric retina identification sensor.

6. The system of claim 5, further comprising a processor having at least one retina matching algorithm for authenticating the retina of said user.

7. The system of claim 1, wherein said biometric authentication module further comprises a biometric fingerprint sensor.

8. The system of claim 7, further comprising a processor having at least one fingerprint matching algorithm for authenticating at least one fingerprint of said user.

9. The system of claim 1, wherein said system further comprises means for detecting a user, wherein said user is physically wearing said eyewear display system by means of at least one of a mechanical switch and an optical detector and an acoustic transducer and an iris image detector and a retinal pattern detector.

10. The system of claim 1, wherein said at least one electrical power source comprises a portable battery.

11. The portable battery of claim 10, wherein said battery is ergonomically attachable to articles of clothing of said user by at least one of a belt clip and/or a fastener device.

12. The system of claim 1, wherein said electrical power source comprises at least one external power source.

13. The signal feed source of claim 1, further including a wireless connection between said signal feed source and said at least one display screen.

14. The signal feed source of claim 1, further including a wired connection between said signal feed source and said at least one display screen.

15. The signal feed source of claim 1, further comprising a miniaturized projection device for projecting said data into at least one eye of said user.

16. The eyewear display system of claim 1, wherein said biometric authentication module is directly attached onto said eyeglasses frame.

17. The eyewear display system of claim 1, wherein said biometric authentication module and said display are directly attached onto an ordinary eyeglasses frame, and wherein said biometric authentication module can be detached therefrom.

18. The eyewear display system of claim 1, wherein said eyeglasses are non-prescription glasses such as at least one of safety goggles and safety glasses.

19. A method for providing biometric authentication of at least one enrolled authorized user of an eyewear display system, comprising the steps of:
enrolling said user into a biometric authentication module attached to an eyeglasses frame of said eyewear display system;
controlling access of said user to said eyewear display system by requiring said user to biometrically authenticate themselves with said attached biometric authentication module; and
allowing said user to access data for which they have access privileges after successful biometric authentication of said user.

20. An apparatus adapted for viewing data by at least one biometrically-authenticated user, comprising:
an eyeglasses frame having at least one biometric authentication module for authenticating said at least one user;
at least one lens mounted within said eyeglasses frame, wherein said lens is adapted for at least one of embedding a miniaturized display screen therewithin and for externally attaching an add-on display screen thereupon;
at least one signal feed source for communicating viewable data from a signal feed source to said display screen after successful biometric authentication of said user by said biometric authentication module; and
at least one electrical power source.

21. The system of claim 1, wherein said data further comprises sensitive data which is assigned a specific security level, including but not limited to at least one of: unclassified data, classified data, confidential data, secret data, top secret data, and special compartmented data.

22. The system of claim 1, wherein communications between said eyeglasses and said signal feed source and said biometric authentication module are protected by at least one of cryptographic authentication and encryption.

23. An external credential interface subsystem for authenticating and relaying externally-provided user identity credentials to an eyewear display system, comprising:
said external credential interface subsystem; and
at least one of a wired connection and a wireless connection for relaying said externally-provided user identity credentials to said eyewear display system.

24. The external credential interface subsystem of claim 23, further comprising at least one biometric credential interface subsystem including at least one of a card reader and an iris reader and a retina reader and a fingerprint reader and a voiceprint recognition interface.

25. The system of claim 1, wherein said data presented from said at least one signal feed source further comprises audio data for presentation to at least one audio speaker disposed within said eyeglasses frame.
